(19) United States
(12) Patent Application Publication
(10) Pub. No.: US 2026/0022600 A1
(43) Pub. Date: Jan. 22, 2026

(54) HINGE ASSEMBLY FOR A VEHICLE

(71) Applicant: GM Global Technology Operations LLC, Detroit, MI (US)

(72) Inventors: Ryan Alexander Barrett, Plymouth, MI (US); James C. O'Kane, Shelby Twp., MI (US); Arthur Lloyd MacNee, III, Grosse IIe, MI (US); Guilherme Augusto Conto, Windsor (CA)

(73) Assignee: GM Global Technology Operations LLC, Detroit, MI (US)

(21) Appl. No.: 18/775,614

(22) Filed: Jul. 17, 2024

(51) Int. Cl. E05D 3/14

(52) U.S. Cl. CPC E05D 3/145; E05Y 2201/712; E05Y 2900/534

(57) ABSTRACT

A hinge assembly includes a knuckle, a mounting plate, a passive arm, a bevel gear head, and an engagement arm. The mounting plate includes a bevel gear and an input shaft. The input shaft is coupled to the knuckle. The passive arm includes a knuckle end and a passive base end. The knuckle end is operably coupled to the knuckle. The bevel gear head includes a plurality of teeth, a detent bearing assembly, and a head receptacle. Teeth of the plurality of teeth are operably coupled to the bevel gear of the mounting plate. The engagement arm includes a gear end, an engagement base end, and a detent. The gear end is operably coupled with both the head receptacle of the bevel gear head and the knuckle. The detent is selectively coupled with the detent-bearing assembly of the bevel gear head.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure generally relates to a hinge assembly, and specifically, a hinge assembly for a panel of a vehicle.

Many hinge mechanisms used in conjunction with a panel are of the four-bar linkage variety that allow the panel to experience rotational motion and translational motion when the panel is opened and closed. When the panel is open, a user may have access to an opening for charging and/or fueling a vehicle. When the panel is closed, the panel seals the opening. However, to properly seal the panel against the opening, rotational motion may hinder sealing performance.

Translational movement, without rotational movement of the panel, is advantageous for sealing the opening, as the panel and the opening will be properly aligned during the initial phase of opening or the final phase of closing. However, rotational movement of the panel limits the amount of translation necessary for the panel to move away from the opening, which creates a more compact hinge mechanism compared to a hinge mechanism that solely offers translational motion. It is desired to have a hinge mechanism attached to a panel that offers both rotational motion and translational motion while still providing sufficient sealing capabilities to the opening on a flat body panel of a vehicle during the initial opening phase and final closing phase of the panel.

### SUMMARY

One aspect of the disclosure provides a hinge assembly. The hinge assembly includes a knuckle, a mounting plate, a passive arm, a bevel gear head, and an engagement arm. The knuckle includes an input shaft receptacle, a passive arm connector, and an engagement arm connector. The mounting plate includes a bevel gear and an input shaft. The input shaft is coupled to the knuckle at the input shaft receptacle. The passive arm includes a knuckle end and a passive base end. The knuckle end is operably coupled to the passive arm connector of the knuckle. The bevel gear head includes a plurality of teeth, a detent bearing assembly, and a head receptacle. Teeth of the plurality of teeth are operably coupled to the bevel gear of the mounting plate. The engagement arm includes a gear end, an engagement base end, and a detent. The gear end is operably coupled with both the head receptacle of the bevel gear head and the engagement arm connector of the knuckle. The detent is selectively coupled with the detent-bearing assembly of the bevel gear head.

Implementations of the disclosure may include one or more of the following optional features. In some examples, the engagement arm may be operable between a closed position and an open position. In some further examples, the detent of the engagement arm may be in an engaged state with the detent bearing assembly of the bevel gear head corresponding to the open position of the engagement arm. In some other further examples, the detent of the engagement arm may be in a disengaged state with the detent bearing assembly of the bevel gear head corresponding to the closed position of the engagement arm. The detent of the engagement arm may be in an engaged state with the detent bearing assembly of the bevel gear head at a detent position when the engagement arm is translated from the closed position to the open position. Further, the detent of the engagement arm may be in a disengaged state with the detent bearing assembly of the bevel gear head at a detent position when the engagement arm is translated from the open position to the closed position.

In some other examples, the mounting plate may be operable between a first phase and a second phase. The first phase includes translational motion corresponding to the engagement arm being disposed between the closed position and the detent position. In some other further examples, the plurality of teeth of the bevel gear head may be statically engaged with the bevel gear of the mounting plate when the engagement arm is translated between the closed position and the detent position. The mounting plate may be operable between a first phase and a second phase. The second phase includes translational motion and rotational motion corresponding to the engagement arm being disposed between the detent position and the open position. In one configuration, the plurality of teeth of the bevel gear head may be operably coupled with the bevel gear of the mounting plate when the engagement arm is translated between the detent position and the open position.

Another aspect of the disclosure provides a panel assembly. The panel assembly includes a panel and a hinge assembly coupled to the panel. The hinge assembly includes a knuckle, a mounting plate, a passive arm, a bevel gear head, and an engagement arm. The knuckle includes an input shaft receptacle, a passive arm connector, and an engagement arm connector. The mounting plate includes a bevel gear and an input shaft. The input shaft is coupled to the knuckle at the input shaft receptacle. The passive arm includes a knuckle end and a passive base end. The knuckle end is operably coupled to the passive arm connector of the knuckle. The bevel gear head includes a plurality of teeth, a detent bearing assembly, and a head receptacle. Teeth of the plurality of teeth are operably coupled to the bevel gear of the mounting plate. The engagement arm is operable between an open position and a closed position and includes a gear end, an engagement base end, and a detent. The gear end is operably coupled with each of the head receptacle of the bevel gear head and the engagement arm connector of the knuckle. The detent is selectively coupled with the detent-bearing assembly of the bevel gear head.

Implementations of this aspect of the disclosure may include one or more of the following optional features. In some examples, the detent of the engagement arm may be in an engaged state with the detent bearing assembly of the bevel gear head when the engagement arm is in the open position. In some implementations, the detent of the engagement arm may be in a disengaged state with the detent bearing assembly of the bevel gear head when the engagement arm is in the closed position. In some aspects, the detent of the engagement arm may be in an engaged state with the detent bearing assembly of the bevel gear head at a detent position when the engagement arm is translated from the closed position to the open position, and the detent of the engagement arm may be in a disengaged state with the detent bearing assembly of the bevel gear head at the detent position when the engagement arm is translated from the open position to the closed position. In some configurations, the mounting plate may be operable between a first phase and a second phase. The first phase includes translational motion corresponding to the engagement arm being disposed between the closed position and the detent position. The second phase includes rotational motion and the translational motion corresponding to the engagement arm being disposed between the detent position and the open position.

Yet another aspect of the disclosure provides a vehicle. The vehicle includes a panel and a hinge assembly. The hinge assembly includes a knuckle, a mounting plate, a passive arm, a bevel gear head, and an engagement arm. The knuckle includes an input shaft receptacle, a passive arm connector, and an engagement arm connector. The mounting plate includes a bevel gear and an input shaft. The input shaft is coupled to the knuckle at the input shaft receptacle. The passive arm includes a knuckle end and a passive base end. The knuckle end is operably coupled to the passive arm connector of the knuckle. The bevel gear head includes a plurality of teeth, a detent bearing assembly, and a head receptacle. Teeth of the plurality of teeth are operably coupled to the bevel gear of the mounting plate. The engagement arm includes a gear end, an engagement base end, and a detent. The gear end is operably coupled with both the head receptacle of the bevel gear head and the engagement arm connector of the knuckle. The detent is selectively coupled with the detent-bearing assembly of the bevel gear head.

Implementations of this aspect of the disclosure may include one or more of the following optional features. In some examples, the engagement arm may be operable between a closed position, a detent position, and an open position. In some further examples, the detent of the engagement arm may be in an engaged state with the detent bearing assembly of the bevel gear head when the engagement arm is in the open position, and the detent of the engagement arm is in a disengaged state with the detent bearing assembly of the bevel gear head when the engagement arm is in the closed position. In some even further examples, the detent of the engagement arm may be in the engaged state with the detent bearing assembly of the bevel gear head at the detent position when the engagement arm is translated from the closed position to the open position, and the detent of the engagement arm may be in the disengaged state with the detent bearing assembly of the bevel gear head at the detent position when the engagement arm is translated from the open position to the closed position.

In some other examples, the mounting plate may be operable between a first phase and a second phase. The first phase includes translational motion corresponding to the engagement arm being disposed between the closed position and the detent position. The second phase includes rotational motion and the translational motion corresponding to the engagement arm being disposed between the detent position and the open position.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle including a hinge assembly;

FIG. 2 is an exploded view of a hinge assembly according to the present disclosure;

FIG. 3A is a perspective view of a hinge assembly according to the present disclosure;

FIG. 3B is another perspective view of the hinge assembly of FIG. 3A;

FIG. 4A is a top plan view of a hinge assembly according to the present disclosure in a closed position;

FIG. 4B is a top plan view of the hinge assembly of FIG. 4A in a detent position;

FIG. 4C is a top plan view of the hinge assembly of FIG. 4B in an open position;

FIG. 4D is a top plan view of the hinge assembly of FIGS. 4A-4C showing the hinge assembly in the detent position and operable between the closed position and the open position;

FIG. 5A is a side view of the hinge assembly of FIG. 4A in the closed position;

FIG. 5B is a side view of the hinge assembly of FIG. 4B in the detent position;

FIG. 5C is a side view of the hinge assembly of FIG. 4C in the open position;

FIG. 5D is a side view of the hinge assembly of FIGS. 5A-5C showing the hinge assembly in the detent position and operable between the closed position and the open position;

FIG. 6A is an enlarged partial top plan view of a bevel gear head and an engagement arm of the hinge assembly of FIG. 4A in the open position; and

FIG. 6B is an enlarged partial top plan view of a bevel gear head and an engagement arm of the hinge assembly of FIG. 4B in the detent position.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

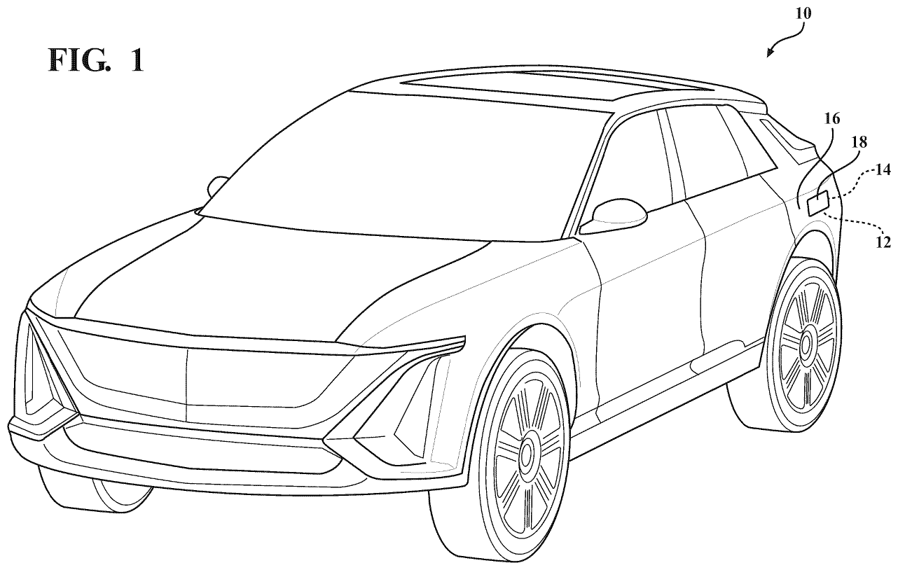

With reference to FIG. 1, a vehicle 10 includes a hinge assembly 12 positioned at or near an opening 14 of the vehicle 10. The opening 14 may be positioned along a body panel 16 of the vehicle 10 that provides user access to a component contained within the opening 14. For example, the component may be accessible when the opening 14 is unobstructed and may be inaccessible when the opening 14 is concealed. The hinge assembly 12 is operable between a closed position 100, a detent position 102, and an open position 104, described in more detail below. Between the closed position 100 and the detent position 102, the hinge assembly 12 is in a first phase 110. For example, the first phase 110 is defined by any position of the hinge assembly 12 during transition from the closed position 100 to the detent position 102 and/or from the detent position 102 to the closed position 100. Between the detent position 102 and the open position 104, the hinge assembly 12 is in a second phase 112. For example, the second phase 112 is defined by any position of the hinge assembly 12 during transition from the detent position 102 to the open position 104 and/or from the open position 104 to the detent position 104. Each position 100, 102, 104 and phase 110, 112 of the hinge assembly 12 is described in more detail below.

A panel 18 is coupled to the hinge assembly 12. For example, the panel 18 may include, but is not limited to, a door, a covering, or any practicable panel that may provide selective access to the opening 14. When the opening 14 is unobstructed, the panel 18 is positioned away from the opening 14, allowing access to the component contained within the opening 14. When the opening 14 is concealed, the panel 18 is positioned within the opening 14 and flush with the body panel 16 of the vehicle 10, preventing access to the component contained within the opening 14. The component contained within the opening 14 may include, but is not limited to, a gas tank filler neck, an electric charging port, and/or storage compartments of the vehicle 10. In some instances, the panel 18 may be configured as a door panel 18 of the vehicle 10, such that the opening 14 may provide access to an interior cabin of the vehicle 10. It should be noted, however, that the opening 14 may be defined in any practicable location along the vehicle 10, such that the dimensions, positioning, and placement of the opening may vary. Further, the component contained within the opening 14 may include any practicable component that may be selectively covered or enclosed by the panel 18 including, but not limited to, fuel or energy ports, and/or the interior cabin of the vehicle.

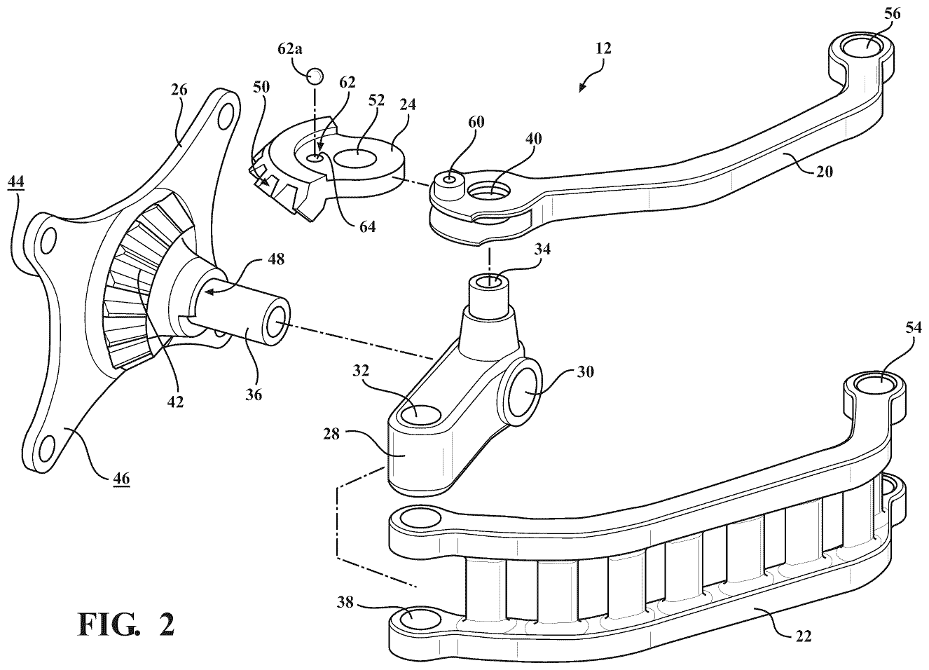

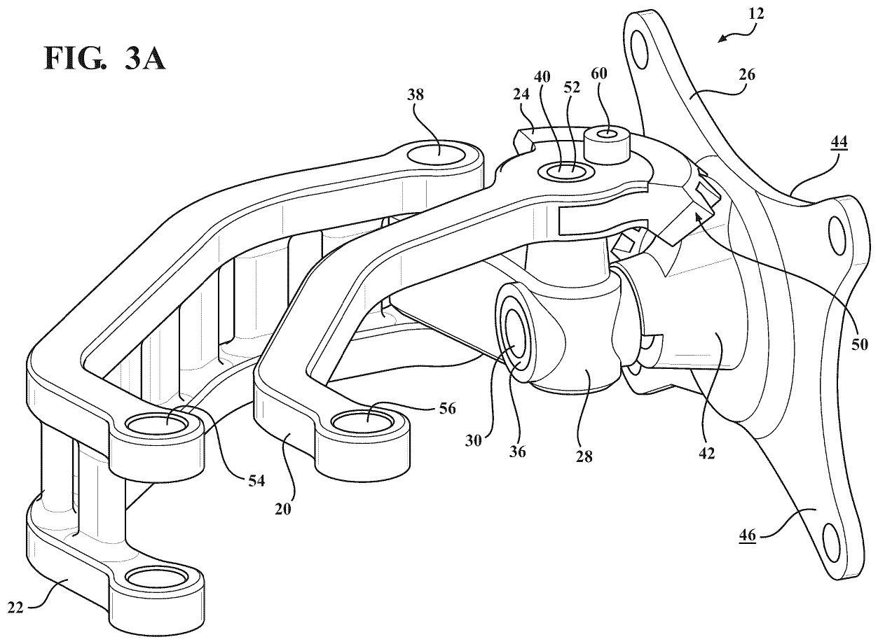

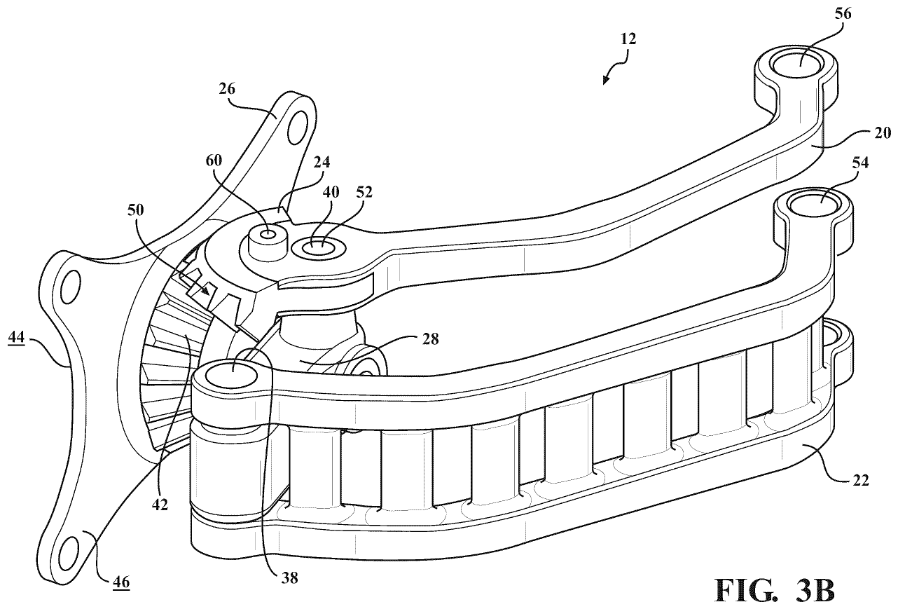

With reference to FIGS. 2-3B, the hinge assembly 12 has a double-rocker four-bar linkage configuration that allows the panel 18, coupled to the hinge assembly 12, to experience both rotational motion and translational motion during operation of the hinge assembly 12 occurs. The hinge assembly 12 includes an engagement arm 20 and a passive arm 22. Both the engagement arm 20 and the passive arm 22 accommodate translational motion of the panel 18 during operation of the hinge assembly 12, described in more detail below. The translational motion of the panel 18 is proportional to a length of each of the engagement arm 20 and the passive arm 22. For example, the greater the length of the engagement arm 20 and the passive arm 22, the greater the translational motion experienced by the panel 18. The hinge assembly 12 also includes a bevel gear head 24, a mounting plate 26, and a knuckle 28, described in greater detail below.

The knuckle 28 of the hinge assembly 12 includes an input shaft receptacle 30, a passive arm connector 32, and an engagement arm connector 34. The knuckle 28 acts as a connector or coupler that interconnects each of the engagement arm 20, the passive arm 22, and the mounting plate 26. The respective connections of the engagement arm 20, the passive arm 22, and the mounting plate 26 at the knuckle 28 facilitate the elements of the hinge assembly 12 to move as a single unit during hinging action of the panel 18. The input shaft receptacle 30 of the knuckle 28 is operably coupled to an input shaft 36 of the mounting plate 26, allowing the input shaft 36 to rotate within the input shaft receptacle 30. The passive arm connector 32 is operably coupled to a knuckle end 38 of the passive arm 22, allowing the passive arm connector 32 to rotate in relation to the knuckle end 38 of the passive arm 22. The engagement arm connector 34 is operably coupled to a gear end 40 of the engagement arm 20, allowing the engagement arm connector 34 to rotate in relation to the gear end 40 of the engagement arm 20.

With further reference to FIGS. 2-3B, the mounting plate 26 of the hinge assembly 12 includes the input shaft 36, a bevel gear 42, a front surface 44 that interfaces with the panel 18, and a rear surface 46 opposite the front surface 44. The bevel gear 42 includes a center area 48 and is positioned against the rear surface 46 of the mounting plate 26. The input shaft 36 is positioned at the center area 48 of the bevel gear 42 in a perpendicular orientation relative to the rear surface 46. The bevel gear 42 is fixed to the rear surface 46 of the mounting plate 26 as a single unit, which prevents the bevel gear 42 from rotating in relation to the rear surface 46 or in relation to other components of the mounting plate 26.

The bevel gear head 24 includes a plurality of teeth 50 operably coupled to the bevel gear 42 of the mounting plate 26, allowing the bevel gear head 24 to rotate along the bevel gear 42 via the plurality of teeth 50. The bevel gear 42 is arranged perpendicular to the plurality of teeth 50. As a result, the mounting plate 26 experiences rotational movement when the plurality of teeth 50 dynamically engage with the bevel gear 42 during hinging action of the hinge assembly 12. The hinging action of the hinge assembly 12 includes a rotational movement of the mounting plate 26 and a translational movement of the mounting plate 26, described in more detail below with respect to the engagement arm 20. The bevel gear head 24 rotates in relation to the bevel gear 42 during simultaneous rotational movement and translational movement of the mounting plate 26, and the bevel gear head 24 is generally free of rotation in relation to the bevel gear 42 when the mounting plate 26 is free of rotational movement, described in greater detail below.

Referring still to FIGS. 2-3B, a head receptacle 52 of the bevel gear head 24 is operably coupled to the gear end 40 of the engagement arm 20 in conjunction with the engagement arm connector 34 of the knuckle 28. For example, both the head receptacle 52 and the engagement arm connector 34 are operably coupled to the gear end 40 of the engagement arm 20 to facilitate movement of the engagement arm 20. The passive arm 22 of the hinge assembly 12 includes a passive base end 54 in addition to the knuckle end 38. As stated above, the knuckle end 38 is operably coupled to the passive arm connector 32 of the knuckle 28. The passive base end 54 is operably coupled to any practicable location at the vehicle 10 where the hinge assembly 12 is accommodated, such as within or proximate to the opening 14. During hinging action of the hinge assembly 12, the passive base end 54 rotates in relation to the vehicle 10, but is fixed from experiencing translational movement in relation to the vehicle 10.

The engagement arm 20 of the hinge assembly 12 includes the gear end 40 operably coupled to the engagement arm connector 34 of the knuckle 28, as stated above. The engagement arm 20 also includes an engagement base end 56 that, similar to the passive base end 54, is operably coupled to any location at the vehicle 10 where the hinge assembly 12 is accommodated, such as within or proximate to the opening 14. Depending on the dimensions of the elements of the hinge assembly 12, all of which may vary depending on the specific application and/or vehicle 10 in which the hinge assembly 12 is installed, the location where the engagement base end 56 is disposed may be the same location or a different location as the location where the passive base end 54 is coupled.

With further reference to FIGS. 2-3B, the engagement arm 20 also includes a detent 60 that is selectively engaged with a detent bearing assembly 62 of the bevel gear head 24. The detent 60 may be engaged with the detent bearing assembly 62, depending on the position of the engagement arm 20. For example, the engagement arm 20 is operable between each of the closed position 100, the detent position 102, and the open position 104, mentioned above and described in more detail below. When the detent 60 is disengaged with the detent bearing assembly 62, the bevel gear head 24 is stationary and free of rotation in relation to the bevel gear 42 of the mounting plate 26. For example, the detent 60 is disengaged from the detent bearing assembly 62 in the first phase 110 of the hinge assembly 12, as mentioned above. As a result, the bevel gear head 24 is free from rotational movement, such that the bevel gear head 24 undergoes translational movement only. When the detent 60 is engaged with the detent bearing assembly 62, the bevel gear head 24 rotates in relation to the bevel gear 42, allowing the mounting plate 26 to undergo both translational and rotational movement simultaneously. For example, the detent 60 is engaged with the detent bearing assembly 62 in the second phase 112 of the hinge assembly 12.

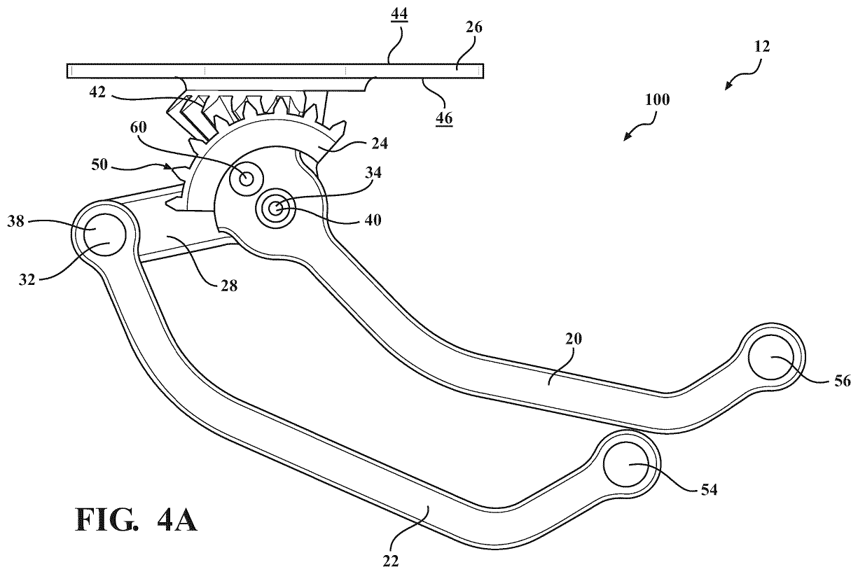

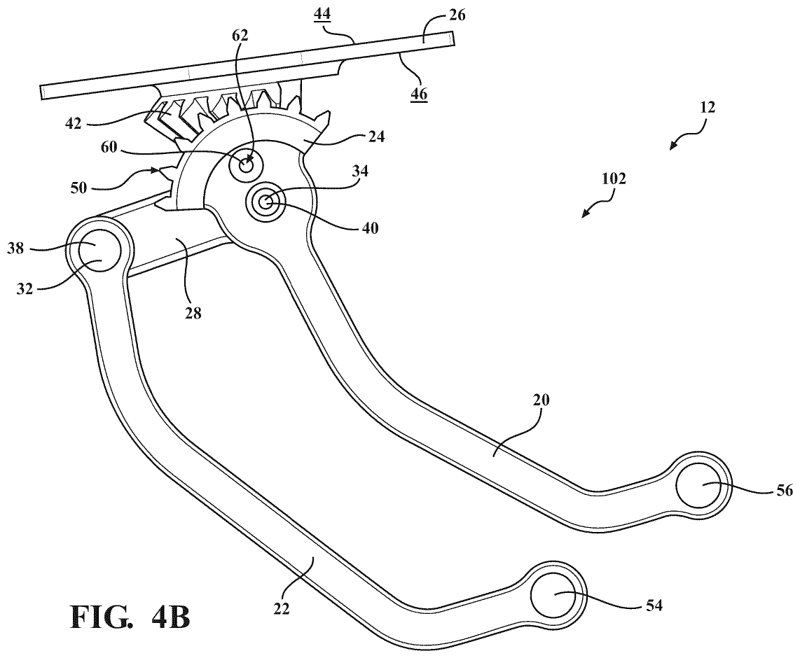

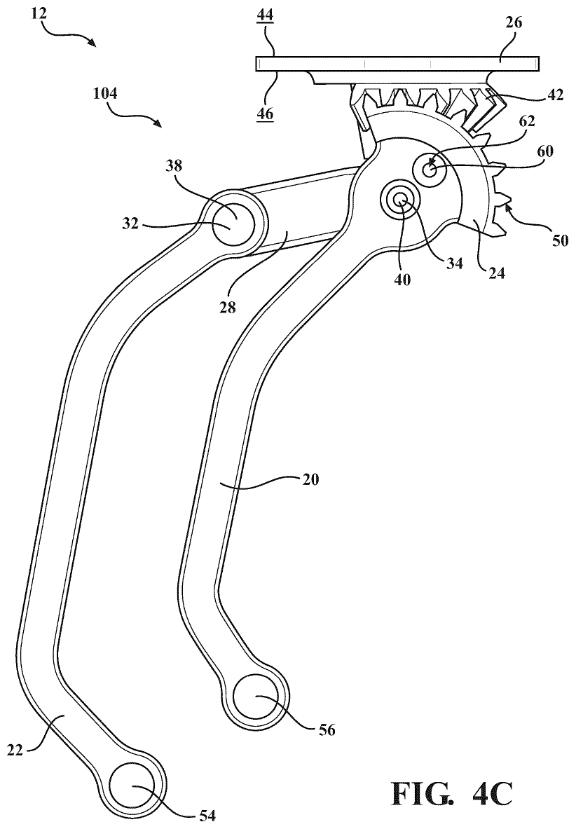

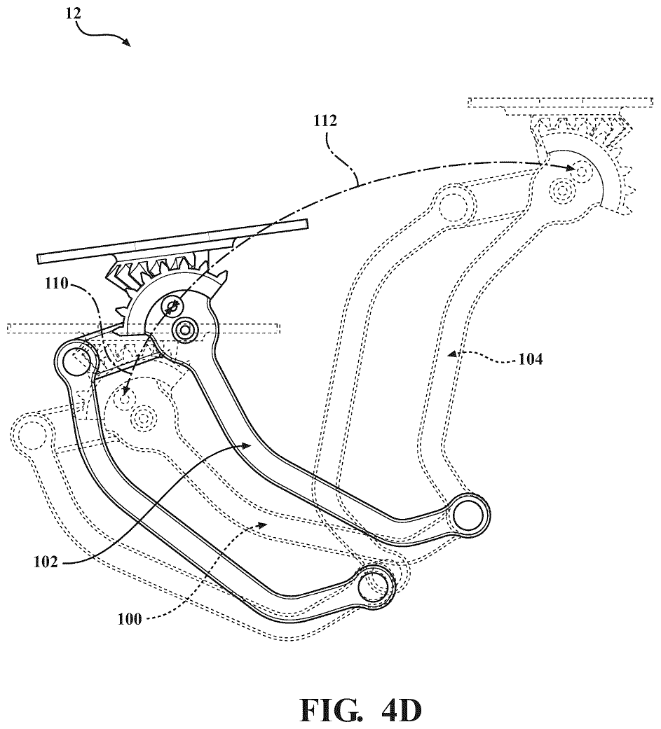

The detent 60 may be a hole, a cavity, or any practicable aperture that is sized and shaped to accommodate the detent bearing assembly 62. The detent bearing assembly 62 may be any configuration that allows selective engagement and disengagement with the detent 60. In one non-limiting example, the detent bearing assembly 62 may include a ball bearing 62a and spring (not shown). The ball bearing 62a and spring may be positioned within a cavity 64 within the bevel gear head 24. During operation, the spring forces the ball bearing 62a to breach the cavity 64 and positions the ball bearing 62a into the detent 60 when the engagement arm 20 is in the detent position 102 (FIG. 4B). The detent position 102 is defined by the detent bearing assembly 62 being at the same position as the detent 60. As the engagement arm 20 translates out of the detent position 102, the spring is compressed and the ball bearing 62a is forced deeper within the cavity 64. When the detent bearing assembly 62 is engaged with the detent 60, the bevel gear head 24 and the engagement arm 20 move as a single unit during hinging action of the hinge assembly 12. When the detent bearing assembly 62 is disengaged from the detent 60, the bevel gear head 24 moves separately from the engagement arm 20.

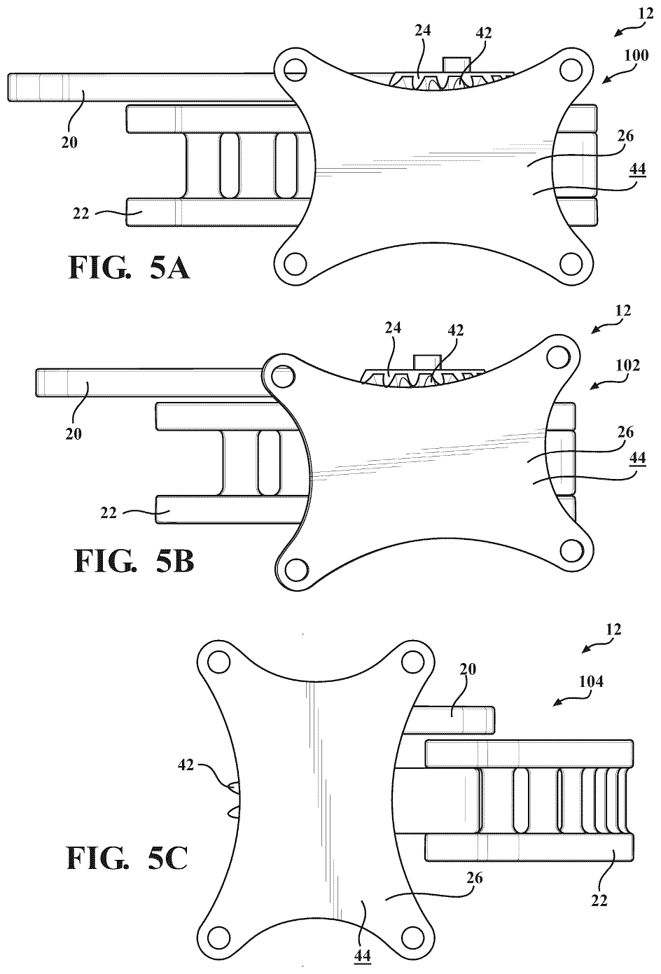

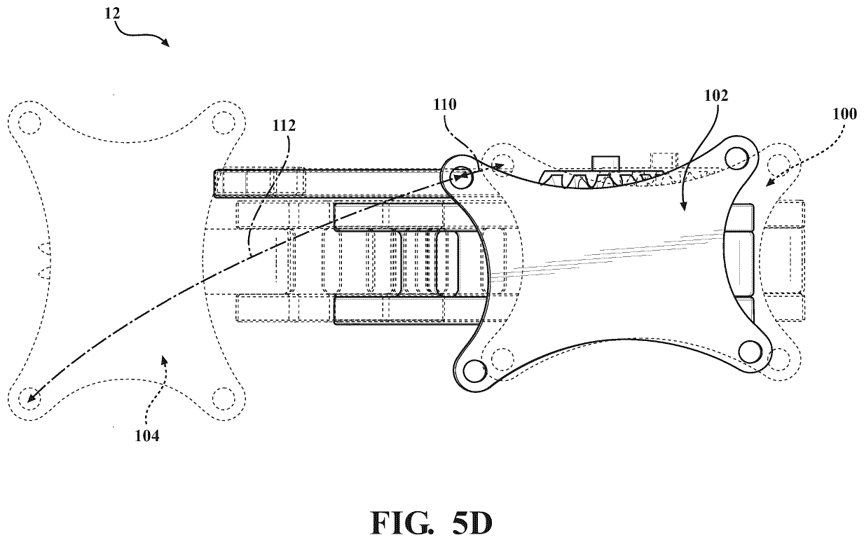

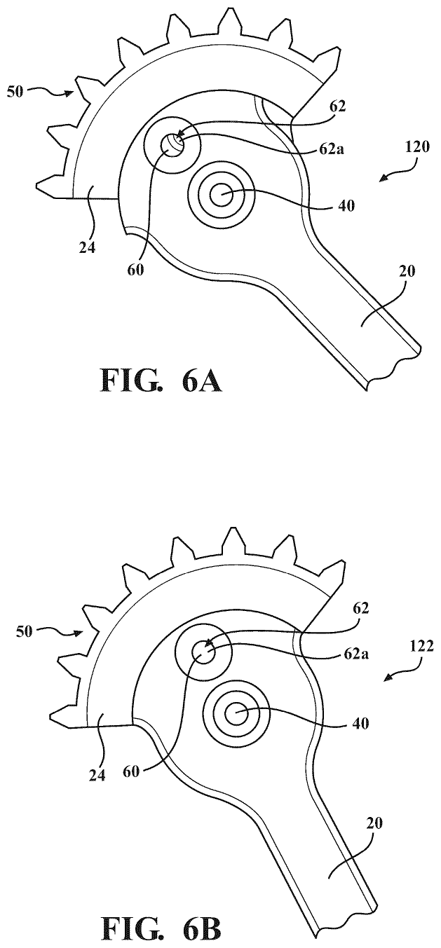

With reference to FIGS. 4A-6B, the engagement arm 20 is operable between the closed position 100 (FIG. 4A and FIG. 5A), the detent position 102 (FIG. 4B and FIG. 5B), and the open position 104 (FIG. 4C and FIG. 5C). During the first phase 110 of the hinge assembly 12, between the closed position 100 and the detent position 102, the detent 60 of the engagement arm 20 is in a disengaged state 120 with the detent bearing assembly 62 of the bevel gear head 24 (FIG. 6A). When the detent 60 is in the disengaged state 120, the bevel gear head 24 and the engagement arm 20 are disengaged from one another and can move independently of one another. For example, the engagement arm 20 may move through the first phase 110 of the hinge assembly 12 independently of the bevel gear head 24. The detent 60 of the engagement arm 20 is in an engaged state 122 with the detent bearing assembly 62 of the bevel gear head 24 during the second phase 112 of the hinge assembly 12, between the detent position 102 and the open position 104 (FIG. 6B). When the detent 60 is in the engaged state 122, the bevel gear head 24 and the engagement arm 20 are fixed together as a single unit and move co-dependently with one another.

The detent position 102 is defined as an intermediate position between the closed position 100 and the open position 104. For example, if the hinging action of the hinge assembly travels from zero (0) percent open at the closed position 100 to 100 percent open at the open position 104, the detent position 102 may be at approximately ten (10) percent open. In other examples, the detent position 102 may be defined as being less than approximately ten (10) percent open or greater than approximately ten (10) percent open depending on the configuration of the vehicle 10 and hinge assembly 12. Each of the closed position 100, the detent position 102, and the open position 104 may at least partially define a respective state of the mounting plate 26 that corresponds with the first phase 110 and the second phase 112 of the hinge assembly 12, mentioned above.

For example, the mounting plate 26, is operable between the first phase 110 and the second phase 112 (FIG. 4D and FIG. 5D) of the hinge assembly 12. The first phase 110 generally corresponds to the hinge assembly 12 moving between the closed position 100 and detent position 102. For example, the first phase 110 of the mounting plate 26 may be defined as any position of the engagement arm 20 between the closed position 100 and the detent position 102. During the first phase 110, the mounting plate 26 only undergoes translational motion and is free of rotational motion. The second phase 112 generally corresponds to the hinge assembly 12 moving between the detent position 102 and the open position 104. For example, the second phase 112 of the mounting plate 26 may be defined as any position of the engagement arm 20 between the open position 104 and the detent position 102. During the second phase 112, the mounting plate 26 undergoes both translational motion and rotational motion between the detent position 102 and the open position 104 of the engagement arm 20.

With reference to FIGS. 6A and 6B, the engagement arm 20 and the bevel gear head 24 are fixed together when the detent 60 of the engagement arm 20 is in the engaged state 122 with the detent bearing assembly 62 of the bevel gear head 24. For example, the bevel gear head 24 moves as one unit with the engagement arm 20 when the detent bearing assembly 62 is engaged with the detent 60. In other words, the engagement arm 20, and the entire hinge assembly 12, can move from the open position 104 to the detent position 102, or move from the detent position 102 to the open position 104, with the engagement arm 20 moving in conjunction with the bevel gear head 24. The engagement of the detent bearing assembly 62 with the detent 60 forces the bevel gear head 24 to rotate in relation to the mounting plate 26. For example, the plurality of teeth 50 of the bevel gear head 24 are dynamically engaged with the bevel gear 42 of the mounting plate 26, which allows the mounting plate 26 to experience rotational movement.

The first phase 110 of the mounting plate is accommodated by the detent 60 of the engagement arm 20 being in the disengaged state 120 with the detent bearing assembly 62 at and between the closed position 100 and the detent position 102. The bevel gear head 24 may experience rotational stalling as a result of the disengagement of the detent bearing assembly 62 with the detent 60. In other words, the engagement arm 20, and the entire hinge assembly 12, can begin moving from the closed position 100 to the detent position 102, or move from the detent position 102 to the closed position 100, with the engagement arm 20 moving independently of the bevel gear head 24. This rotational stall prevents the bevel gear head 24 from rotating in relation to the mounting plate 26, as the plurality of teeth 50 of the bevel gear head 24 are only statically engaged with the bevel gear 42 of the mounting plate 26, which prevents the mounting plate 26 from experiencing any sort of rotational motion.

In the following example, a scenario wherein the hinge assembly 12 moves from the closed position 100 to the open position 104, with the panel 18 attached to the hinge assembly 12 at the vehicle 10, is described. When the hinge assembly 12 initially begins traveling from the closed position 100, the panel 18 and the mounting plate 26 undergo translational motion as each initially moves away from the opening 14. The initial movement of the hinge assembly 12 is generally associated with the first phase 110 of the mounting plate 26, such that the hinge assembly 12 is between the closed position 100 and the detent position 102. During this portion of movement, or the first phase 110, the engagement arm 20 moves independently from the bevel gear head 24, as the detent 60 is in the disengaged state 120 with the detent bearing assembly 62.

As the hinge assembly 12 reaches the detent position 102, the detent bearing assembly 62 enters the engaged state 122 and becomes engaged with the detent 60. At this point, the engagement arm 20 becomes fixed to the bevel gear head 24. As the hinge assembly 12 continues from the detent position 102 to the open position 104, or the second phase 112, the panel 18 and the mounting plate 26 undergo both translational motion and rotational motion. From the detent position 102 to the open position 104, the panel 18 and the mounting plate 26 may rotate a predetermined degree, while continuing to simultaneously translate away from the opening 14. By way of example, not limitation, the predetermined degree of rotation may be approximately ninety (90) degrees. The rotational movement experienced by the panel 18 and the mounting plate 26 is advantageous to allow the panel 18 to move away from the opening 14 while keeping the dimensions of the hinge assembly 12 compact. Once the hinge assembly 12 reaches the open position 104, the opening 14 is fully accessible.

In the following example, a scenario wherein the hinge assembly 12 moves from the open position 104 to the closed position 100, with the panel 18 attached to the hinge assembly 12 at the vehicle 10, is described. When the hinge assembly 12 initially begins traveling from the open position 104 to the closed position 100, the panel 18 and the mounting plate 26 undergo simultaneous translational motion and rotational motion as each moves towards the opening 14. During the initial movement, or the second phase 112, the engagement arm 20 moves in conjunction with the bevel gear head 24, as the detent bearing assembly 62 is in the engaged state 122 with the detent 60. As the hinge assembly 12 reaches the detent position 102, the detent bearing assembly 62 enters the disengaged state 120 and becomes disengaged with the detent 60. At this point, the engagement arm 20 is free and operably independent of the bevel gear head 24.

As the hinge assembly 12 continues from the detent position 102 to the closed position 100, or the first phase 110, the panel 18 and the mounting plate 26 are free of rotational motion and only experience translational motion as each continues to move towards the opening 14. The lack of rotational movement experienced by the panel 18 and the mounting plate 26 is advantageous to allow the panel 18 to sufficiently and effectively seal at the opening 14 and become flush with the body panel 16 of the vehicle 10. Once the hinge assembly 12 reaches the closed position 100, the opening 14 is covered and inaccessible.

Referring again to FIGS. 1-6B, the singular, translational movement of mounting plate 26 in the first phase 110 is advantageous to provide sufficient sealing and/or alignment of the panel 18 at the opening 14 of the vehicle 10. The alignment of the panel 18 via the translational movement is especially beneficial when the opening 14 is positioned at a relatively flat body panel 16, such as a slab-sided exterior body panel 16 of a vehicle 10. The detent 60 may be defined at the engagement arm 20 in various positions depending on the degree of rotational movement that is practicable for the panel 18 prior to sealing. For example, it is advantageous to minimize the rotational movement in the final moment of the hinging action of the hinge assembly 12, such that the detent 60 may be defined towards an edge of the engagement arm 20.

In other words, sealing of the panel 18 relative to the body panel 16 is improved by the singular translational movement of the hinge assembly 12 as the engagement arm 20 enters the closed position 100. Likewise, it is advantageous for the panel 18 to only experience translational motion to facilitate a smooth and effective opening of the panel 18. Once the panel 18 is positioned slightly away from the opening 14, the panel can experience both rotational motion and translational motion, as the panel 18 is no longer engaged with the opening 14.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A hinge assembly comprising:
a knuckle including an input shaft receptacle, a passive arm connector, and an engagement arm connector;
a mounting plate including a bevel gear and an input shaft, the input shaft coupled to the knuckle at the input shaft receptacle;
a passive arm including a knuckle end and a passive base end, the knuckle end operably coupled to the passive arm connector of the knuckle;
a bevel gear head including a plurality of teeth, a detent bearing assembly, and a head receptacle, the plurality of teeth operably coupled to the bevel gear of the mounting plate; and
an engagement arm including a gear end, an engagement base end, and a detent, the gear end operably coupled with both the head receptacle of the bevel gear head and the engagement arm connector of the knuckle, the detent selectively coupled with the detent-bearing assembly of the bevel gear head.

2. The hinge assembly of claim 1, wherein the engagement arm is operable between in a closed position and an open position.

3. The hinge assembly of claim 2, wherein the detent of the engagement arm is in an engaged state with the detent bearing assembly of the bevel gear head corresponding to the open position of the engagement arm.

4. The hinge assembly of claim 2, wherein the detent of the engagement arm is in a disengaged state with the detent bearing assembly of the bevel gear head corresponding to the closed position of the engagement arm.

5. The hinge assembly of claim 3, wherein the detent of the engagement arm is in an engaged state with the detent bearing assembly of the bevel gear head at a detent position when the engagement arm is translated from the closed position to the open position

6. The hinge assembly of claim 3, wherein the detent of the engagement arm is in a disengaged state with the detent bearing assembly of the bevel gear head at a detent position when the engagement arm is translated from the open position to the closed position.

7. The hinge assembly of claim 2, wherein the mounting plate is operable between a first phase and a second phase, the first phase including translational motion corresponding to the engagement arm being disposed between the closed position and the detent position.

8. The hinge assembly of claim 7, wherein the plurality of teeth of the bevel gear head are statically engaged with the bevel gear of the mounting plate when the engagement arm is translated between the closed position and the detent position.

9. The hinge assembly of claim 2, wherein the mounting plate is operable between a first phase and a second phase, the second phase including translational motion and rotational motion corresponding to the engagement arm being disposed between the detent position and the open position.

10. The hinge assembly of claim 9, wherein the plurality of teeth of the bevel gear head are operably coupled with the bevel gear of the mounting plate when the engagement arm is translated between the detent position and the open position.

11. A panel assembly comprising:
a panel; and
a hinge assembly coupled to the panel, the hinge assembly including:
a knuckle including an input shaft receptacle, a passive arm connector, and an engagement arm connector;
a mounting plate including a bevel gear and an input shaft, the input shaft coupled to the knuckle at the input shaft receptacle;
a passive arm including a knuckle end and a passive base end, the knuckle end operably coupled to the passive arm connector of the knuckle;
a bevel gear head including a plurality of teeth, a detent bearing assembly, and a head receptacle, the plurality of teeth operably coupled to the bevel gear of the mounting plate; and
an engagement arm operable between an open position and a closed position and including a gear end, an engagement base end, and a detent, the gear end operably coupled with each of the head receptacle of the bevel gear head and the engagement arm connector of the knuckle, the detent selectively coupled with the detent-bearing assembly of the bevel gear head.

12. The panel assembly of claim 11, wherein the detent of the engagement arm is in an engaged state with the detent bearing assembly of the bevel gear head when the engagement arm is in the open position.

13. The panel assembly of claim 11, wherein the detent of the engagement arm is in a disengaged state with the detent bearing assembly of the bevel gear head when the engagement arm is in the closed position.

14. The panel assembly of claim 11, wherein the detent of the engagement arm is in an engaged state with the detent bearing assembly of the bevel gear head at a detent position when the engagement arm is translated from the closed position to the open position, and the detent of the engagement arm is in a disengaged state with the detent bearing assembly of the bevel gear head at the detent position when the engagement arm is translated from the open position to the closed position.

15. The panel assembly of claim 11, wherein the mounting plate is operable between a first phase and a second phase, the first phase including translational motion corresponding to the engagement arm being disposed between the closed position and the detent position, the second phase including rotational motion and the translational motion corresponding to the engagement arm being disposed between the detent position and the open position.

16. A vehicle comprising:
a panel; and
a hinge assembly including:
a knuckle including an input shaft receptacle, a passive arm connector, and an engagement arm connector;
a mounting plate including a bevel gear and an input shaft, the input shaft coupled to the knuckle at the input shaft receptacle;
a passive arm including a knuckle end and a passive base end, the knuckle end operably coupled to the passive arm connector of the knuckle;
a bevel gear head including a plurality of teeth, a detent bearing assembly, and a head receptacle, the plurality of teeth operably coupled to the bevel gear of the mounting plate; and
an engagement arm including a gear end, an engagement base end, and a detent, the gear end operably coupled with both the head receptacle of the bevel gear head and the engagement arm connector of the knuckle, the detent selectively coupled with the detent-bearing assembly of the bevel gear head.

17. The vehicle of claim 16, wherein the engagement arm is operable between a closed position, a detent position, and an open position.

18. The vehicle of claim 17, wherein the detent of the engagement arm is in an engaged state with the detent bearing assembly of the bevel gear head when the engagement arm is in the open position, the detent of the engagement arm being in a disengaged state with the detent bearing assembly of the bevel gear head when the engagement arm is in the closed position.

19. The vehicle of claim 18, wherein the detent of the engagement arm is in the engaged state with the detent bearing assembly of the bevel gear head at the detent position when the engagement arm is translated from the closed position to the open position, and the detent of the engagement arm is in the disengaged state with the detent bearing assembly of the bevel gear head at the detent position when the engagement arm is translated from the open position to the closed position.

20. The vehicle of claim 17, wherein the mounting plate is operable between a first phase and a second phase, the first phase including translational motion corresponding to the engagement arm being disposed between the closed position and the detent position, the second phase including rotational motion and the translational motion corresponding to the engagement arm being disposed between the detent position and the open position.
